(19) United States
(12) Patent Application Publication
(10) Pub. No.: US 2006/0258867 A1
(43) Pub. Date: Nov. 16, 2006

(54) Transition metal complexes, especially iron complexes, used as a catalyst component in the polymerisation of olefins

(76) Inventors: Vernon Charles Gibson, London (GB); Rachel Kerry O'Reilly, County Down (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/549,239

(22) PCT Filed: Mar. 12, 2004
(86) PCT No.: PCT/GB04/01071

§ 371 Date: Jun. 15, 2006

(30) Foreign Application Priority Data
Mar. 14, 2003 (GB) 0305927.6

(51) Int. Cl. C07F 15/00

(52) U.S. Cl. 546/2; 548/101

(57) ABSTRACT

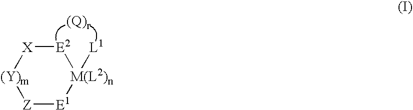

The present invention relates to compounds of formula (I) wherein each of X, Y, Z is independently selected from O, S, NR¹, CR²R³, N and CR⁴, and where optionally X—Y, Y-Z, Z-E¹ and X-E² each independently form part of a saturated or unsaturated ring system which may be substituted or unsubstituted; m is 0 or 1; M is a metal selected from Ti[III], Ti[IV], Fe[II], Fe[III], Co[I], Co[II], Co[III], Ni[II], Cr[III], Mn[II], Mn[III], Mn[IV], Ru[II], Ru[III], Ru[IV], Pd[II], V[II], V[III], V[IV], V[V], Cu[I], Cu[II], Rh[I], Rh[III], Mo[III], Mo[V], Re[I] and Re[II]; each of E¹ and E² is independently selected from O, S, NR⁵, N, P, PR⁶, where at least one of either E¹ or E² carries a formal negative charge; L² is a one electron donor ligand; n is zero or an integer such that the compound has an overall charge of zero or +1; L¹ is NR⁷R^{B}, PR⁷R^{B}, OR⁷, SR⁷, O, S or NR¹⁶, imidazolyl, pyridinyl, benzimidazolyl or quinolinyl; each of R¹⁻⁸ and R¹⁶ is independently H or a hydrocarbyl group; Q is a linker group; and r is 0 or 1. Further aspects of the invention relate to catalyst compositions comprising compounds of formula (I), and their use in the polymerisation of olefinically unsaturated monomers.

The present invention relates to novel metal-ligand complexes and catalyst compositions thereof. The invention further relates to the use of said complexes and catalyst compositions in the polymerisation of olefinically unsaturated monomers.

### BACKGROUND TO THE INVENTION

A recent development in the control of radical polymerisation systems is atom transfer radical polymerisation (ATRP) based on a redox reaction with a transition metal compound. ATRP is believed to result from two parameters (i) the presence of a low constant concentration of growing radicals and (ii) a fast and reversible equilibrium between the growing radicals and the dormant polymer species. If the concentration of growing radicals is kept low enough, and a fast and reversible equilibrium between growing radicals and the dormant polymer species is established, the proportion of termination reactions in comparison to propagation can be minimised which results in better predictability of molecular weight and lower polydispersities. A more detailed discussion of the mechanism of ATRP may be found in WO 96/30421. This describes a method for atom or group transfer radical polymerisation of an alkene such as styrene whereby the alkene is polymerised in the presence of an initiator, a transition metal compound and a ligand and the formed polymer is subsequently isolated. The use of an alkyl halide initiator, copper (I) chloride, and bipyridine ligand to produce controlled molecular weight polymers of low polydispersity is described.

However the process described in WO 96/30421 has the disadvantage that it is a heterogeneous system due to the fact that the copper catalyst is only partially soluble in the polymerisation system. Thus, it is difficult to determine the level of active catalyst in the polymerisation system, and difficult to predict or control the properties, e.g. molecular weight of the final product. Heterogeneous ATRP catalysts are also well known to be less efficient than homogeneous catalysts in terms of g/g productivity, and also require specific separation steps from the product in commercial use. As a result, homogeneous systems are generally preferred where possible.

WO 97/47661 describes the use of copper diimine complexes which allow homogeneous atom transfer polymerisation of olefinically unsaturated monomers and thus the level of active catalyst in the mixture to be controlled. However, the rates of conversion for styrene using these complexes are relatively low, and the polydispersities (Mw/Mn) are relatively high.

WO 99/58578 discloses a catalyst composition comprising iron complexes containing diimine ligands. Metals such as iron, with good biocompatibility, are preferred, if the polymers produced are to be used in the construction of medical devices.

The present invention seeks to provide new metal-ligand complexes and catalyst compositions thereof, particularly those which have applications in the field of atom transfer radical polymerisation. More specifically, the invention seeks to provide catalyst compositions that lead to the production of controlled molecular weight polymers having low polydispersities.

### STATEMENT OF INVENTION

A first aspect of the present invention relates to compounds of formula I 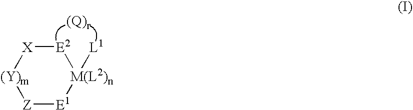
wherein
each of X, Y, Z is independently selected from O, S, NR¹, CR²R³, N and CR⁴, and where optionally X—Y, Y-Z, Z-E¹ and X-E² each independently form part of a saturated or unsaturated ring system which may be substituted or unsubstituted;
m is 0 or 1;
M is a metal selected from Ti[M], Ti[IV], Fe[II], Fe[III], Co[I], Co[II], Co[III], Ni[II], Cr[III], Mn[II], Mn[III], Mn[IV], Ru[II], Ru[III], Ru[IV], Pd[II], V[II], V[III], V[IV], V[V], Cu[I], Cu[II], Rh[I], Rh[III], Mo[III], Mo[V], Re[I] and Re[II];
each of E¹ and E² is independently selected from O, S, NR⁵, N, P, PR⁶, where at least one of either E¹ or E² carries a formal negative charge;
L² is a one electron donor ligand;
n is zero or an integer such that the compound has an overall charge of zero or +1;
L¹ is NR⁷R⁸, PR⁷R⁵, OR⁷, SR⁷, O, S or NR¹⁶ imidazolyl, pyridinyl, benzimidazolyl or quinolinyl;
each of R¹⁻⁸ and R¹⁶ is independently H or a hydrocarbyl group;
Q is a linker group; and
r is 0 or 1.

A second aspect of the invention relates to a catalyst composition comprising a compound as defined above and an initiator.

A third aspect of the invention relates to the use of a compound or catalyst composition as defined above for polymerising a radically polymerisable monomer.

A fourth aspect provides a process for polymerising a radically polymerisable monomer, said process comprising contacting a catalyst composition according to the invention with said radically polymerisable monomer, optionally in the presence of a solvent.

A fifth aspect relates to a polymerisation mixture comprising a catalyst composition according to the invention and a radically polymerisable monomer, which optionally further comprises a solvent and/or a Lewis acid activator.

### DETAILED DESCRIPTION

As used herein, the term “hydrocarbyl” refers to a group comprising at least C and H that may optionally comprise one or more other suitable substituents. Examples of such substituents may include halo-, alkoxy-, nitro-, an alkyl group, or a cyclic group. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group. Thus, the hydrocarbyl group may contain heteroatoms. Suitable heteroatoms will be apparent to those skilled in the art and include, for instance, sulphur, nitrogen, oxygen, phosphorus and silicon.

As used herein, the term “aryl” refers to an aromatic group which may be substituted (mono- or poly-) or unsubstituted, fused or unfused. Suitable substituents include halo-, alkoxy-, nitro-, an alkyl group, or a cyclic group.

As used herein, the term “heteroaryl group” refers to an aromatic heterocycle comprising one or more heteroatoms. Preferred heteroaryl groups include pyrrole, pyrimidine, pyrazine, pyridine, quinoline and furan.

In one preferred embodiment of the invention, one or more of X—Y, Y-Z, Z-E¹ and X-E² may form part of a saturated or unsaturated ring system, which may be substituted or unsubstituted. By way of example, suitable ring systems include aryl, heteroaryl or alicyclic systems.

As used herein, the term “alicylic” refers to moiety that contains a ring of atoms and is aliphatic (i.e., non-aromatic), which may optionally contain one or more heteroatoms. Suitable heteroatoms will be apparent to those skilled in the art and include, for instance, sulphur, nitrogen, oxygen, phosphorus and silicon.

Suitable substituents for the saturated or unsaturated ring systems include ether, thioether, ester, dialkylamino, cyano, halo, nitro, an alkyl group, or a cyclic group, NR¹⁷R¹⁸R¹⁹⁺, NHR²⁰R²¹⁺, NH₂R²²⁺, NH₃⁺, PR²³R²⁴R²⁵⁺, PHR²⁶R²⁷⁺, PH₂R²⁸⁺, PH₃⁺ and sulphonate, i.e. SO₃H, SO₃Na, where R¹⁷⁻²⁸ are each independently H or alkyl.

The skilled person will appreciate that X—Y, Y-Z, Z-E¹ or X-E² may have partial double bond character if they form part of a delocalised ring system such as an aromatic or heterocyclic ring.

One preferred embodiment of the invention relates to compounds of formula I wherein: each of X, Y, Z is independently selected from O, S, NR¹, CR²R³, N and CR⁴, and where optionally X—Y, Y-Z, Z-E¹ and X-E² each independently form part of a saturated or unsaturated ring system which may be substituted or unsubstituted;

m is 0 or 1;

M is a metal selected from Ti[III], Ti[IV], Fe[II], Fe[III], Co[I], Co[II], Co[III], Ni[II], Cr[III], Mn[II], Mn[III], Mn[IV], Ru[II], Ru[III], Ru[IV], Pd[II], V[II], V[III], V[IV], V[V], Cu[I], Cu[II], Rh[I], Rh[III], Mo[III], Mo[V], Re[I] and Re[II];

each of E¹ and E² is independently selected from O, S, NR⁵, N, P, PR⁶, where at least one of either E¹ or E² carries a formal negative charge;

L² is a one electron donor ligand;

n is an integer such that the compound has an overall charge of zero;

L¹ is NR⁷R⁸, PR⁷R⁸, OR⁷, SR⁷, imidazolyl, pyridinyl, benzimidazolyl or quinolinyl;

each of R¹⁻⁸ is independently H or a hydrocarbyl group;

Q is a linker group; and r is 0 or 1.

In one preferred embodiment of the invention, L² is selected from halide, hydride, alkyl and cyanide.

In one preferred embodiment of the invention, L² is chloride or bromide.

Preferably, X, Y and Z are each independently selected from CR²R³ and CR⁴.

Preferably, one of either E¹ or E² carries a formal negative charge.

In one preferred embodiment of the invention,
(i) m is 1, each of X-E² and Y-Z is independently a single or a double bond or part of a delocalised π system, and X—Y and Z-E¹ are single bonds; or
(ii) m is 1, each of X—Y and Z-E¹ is independently a single or a double bond or part of a delocalised π system, and Z-E² and Y-Z are single bonds; or
(iii) m is 0, each of X-E² and Z-E¹ is independently a single or a double bond or part of a delocalised π system, and X-Z is a single bond;

In one preferred embodiment, m is 1 and Y-Z forms part of a saturated or unsaturated ring system. More preferably still, Y-Z is a double bond or part of a delocalised π system.

In an even more preferred embodiment of the invention, m is 1, Y-Z is a double bond or part of a delocalised π system, and X-E² is a single or a double bond.

In one particularly preferred embodiment, the compound is of formula II 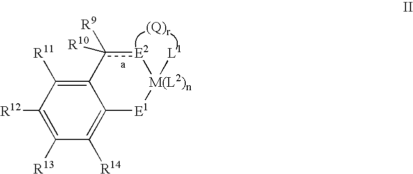
wherein each of R⁹⁻¹⁴ is independently H, a hydrocarbyl group, a halide, ether, thioether, ester, nitro, dialkylamino, or cyano group, and “a” is a double bond or part of a delocalised π system (where one of R⁹ or R¹⁰ is absent), or “a” is a single bond.

In one preferred embodiment, X-E² is a double bond or part of a delocalised π system, and E² is N.

In another preferred embodiment, X-E² is single bond and E² is NR⁵.

In another preferred embodiment, Z-E¹ is a single bond and E¹ is O.

In one particularly preferred embodiment, the compound is of formula III or IV 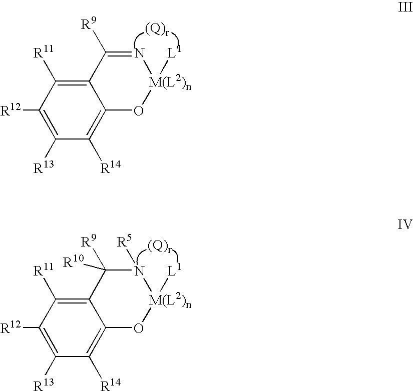
wherein each of R⁹⁻¹⁴ is independently H, a hydrocarbyl group, a halide, ether, thioether, ester, nitro, dialkylamino, or cyano group.

In one especially preferred embodiment, M is Fe.

Even more preferably, L² is chloride and n is one or two.

In another particularly preferred embodiment of the invention, m is 0, X-E² and Z-E¹ are both double bonds or each form part of a delocalised π system, and X-Z is a single bond.

More preferably, in respect of this embodiment, the compound is of formula V, VI or VII

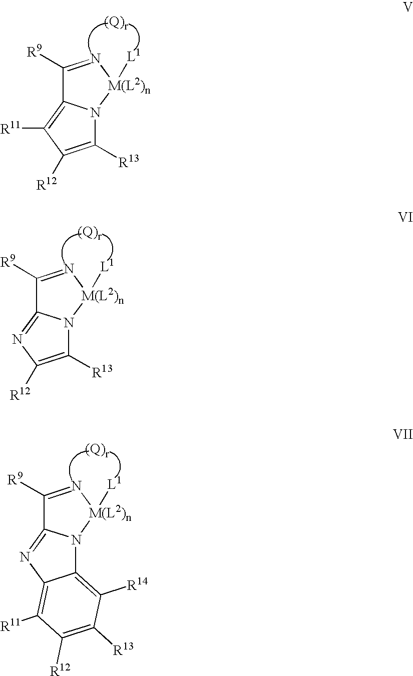

In a preferred embodiment, L¹ is selected from the following: —O, —S, —NR¹⁶,

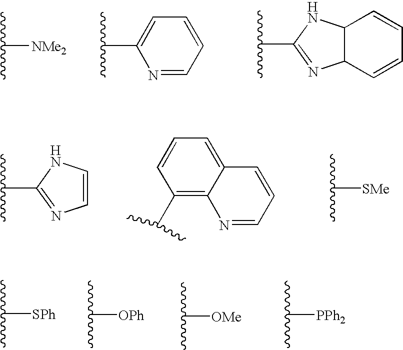

Preferably, the linker group Q is —(CHR¹⁵)ₚ— or a phenylene group, where p is 1, 2, 3 . . . 10, and each R¹⁵ is independently H or a hydrocarbyl group.

Even more preferably, the linker group Q is —(CH₂)ₚ— where p is one or two, or o-phenylene.

In one particularly preferred embodiment, r is 1.

In one particularly preferred embodiment, each R¹⁻¹⁵ is independently H, a C₁₋₅₀ alkyl, or a C₁-C₅₀ alkene each of which may optionally comprising one or more heteroatoms, an aryl, or a heteroaromatic group.

More preferably, each R¹⁻¹⁶ is independently H, a C₁-C₂₀ alkyl, a C₁-C₂₀ alkene, a C₁-C₂₀ aryl or a C₁-C₂₀ heteroaromatic group.

Even more preferably, each R¹⁻¹⁶ is independently a C₁₋₂₀ alkyl group, more preferably a C₁₋₁₀ alkyl group, more preferably still a C₁₋₆ alkyl group, preferably Me, Et, ⁿPr, ⁱPr, ⁿBu, ⁱBu or ^{t}Bu.

In one especially preferred embodiment, the compound of the invention is selected from the following:

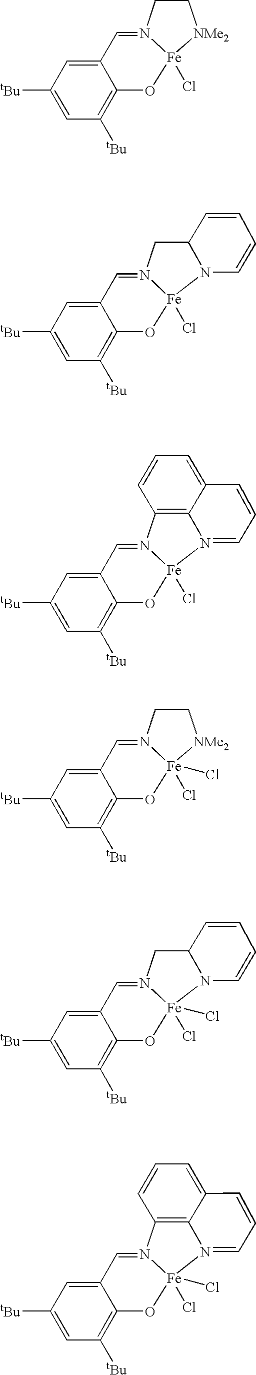

Another aspect of the invention relates to a composition comprising a compound of formula I as defined hereinabove and an initiator.

In one preferred embodiment, the catalyst composition comprises more than one compound of formula I.

As used herein, the term “initiator” refers to an agent used to start the polymerisation of a monomer.

Preferably, the initiator has a radically transferable atom or group.

Preferably, the compounds of formula I may be supported on an inorganic or organic solid support.

Preferably, the initiator suitable for use in the present invention may be any initiator having a radically transferable atom or group. Examples of suitable initiators include conventional atom transfer radical addition initiators, for example, organic halides, such as alkyl halides, e.g. alkyl chlorides or bromides such as CCl₄, CHCl₃ and CCl₃Br, activated alkyl halides e.g. alkyl halides containing at least one electron withdrawing group in the alpha-position such as an ester, such as halopropionates or halomalonates, e.g. 2-bromoethylisobutyrate or a ketone, e.g. 2-bromoisobutyrophenone or an optionally substituted aryl e.g. phenyl or nitro-substituted phenyl. Other suitable initiators include arenesulphonyl halides, particularly chlorides, which can be substituted or unsubstituted, such as para-toluenesulphonyl chloride and paramethoxybenzenesulphonyl chloride. Particularly preferred initiators include CCl₄ and para-toluenesulphonyl chloride, and also phenoxybenzene-4,4′-disulphonyl halides such as phenoxybenzene-4,4′-disulphonyl chloride.

It will be understood that such initiators may also be molecules (monomeric or polymeric) which contain more than one radically transferrable atom or group. Examples of monomeric multifunctional initiators include alkyl dihalides and sulphonyl halides such as 1,3-benzene disulphonyl chloride.

Suitable initiators for the invention also include polymers, which may optionally be based on styrene, which contain one or more radically transferable group present at the chain ends and/or pendent to the main chain and distributed along its length. As described in WO 98/01480, for example, such initiator molecules may also contain within them other functional groups which are not active to radical polymerisation but which can be used to initiate anionic or cationic living polymerisation of other monomers. In this way a variety of block copolymer architectures can be accessed. It will be understood that such multifunctional initiators provide access to a wide range of star branched and grafted homopolymer and copolymer architectures with the consequent enhanced potential to fine-tune properties. The use of mixed initiators is also within the scope of the invention.

It is also possible to conduct the polymerisation in reverse ATRP mode where the metal complex controls the activity of radicals generated by conventional radical initiators known to those skilled in the art, such as peroxide and azo functional molecules. In this mode of operation the complex must first exchange a radically transferable atom or group onto polymerising radicals generated by the initiator. In carrying out this function the metal is reduced in oxidation state and therefore must be present initially in the oxidised form of its redox couple. In this mode of operation at least one of the ligands must be selected to provide the radically transferable group, for example halide. In reactions where initiation is performed with a molecule already containing an atom or group which can radically transfer to the metal complex in the initiation step then it will be understood the metal should be present in the reduced form of its redox couple. In this mode of operation it is not necessary for one of the ligands to be a radically transferable group as this is supplied by the initiator.

Preferably, for reverse ATRP mode, the initiator is AIBN {2,2′-azobis(isobutyronitrile)}.

Another aspect of the invention relates to the use of a compound of formula I as defined herein as a polymerisation catalyst for radically polymerisable monomers.

Yet another aspect of the invention relates to the use of the above-defined composition as a polymerisation catalyst for radically polymerisable monomers.

The present invention further provides a process for the polymerization and copolymerisation of a radically polymerisable monomer, comprising contacting said monomer under polymerisation conditions with a catalyst composition as defined above.

Monomers suitable for use in the polymerisation process of the present invention include any radically polymerisable monomer, or mixtures of two or more of such monomers. Preferred monomers include ethylene; optionally substituted conjugated dienes such as 1,3-butadiene, isoprene; acids and anhydrides such as acrylic acid or acrylic anhydride; (meth)acrylamides; vinyl halides e.g. vinyl chloride, (meth)acrylonitrile; (meth)acrylate esters of C₁₋₂₀ alcohols e.g. methyl methacrylate, ethyl methacrylate, propyl methacrylate (all isomers), butyl methacrylate (all isomers); vinyl esters of C₁₋₂₀ alcohols e.g. vinyl acetate, vinyl propionate or vinyl butyrate; vinyl amides such as vinyl pyrrolidone, and other vinyl amides having up to 8 carbon atoms; vinyl ketones such as methylvinyl ketone, ethylvinyl ketone, butylvinyl ketone and other vinyl ketones having up to 8 carbon atoms; vinyl substituted aryls e.g. vinyl substituted phenyls, vinyl substituted naphthyls. The aryl ring may be substituted by at least one vinyl group such as 1-2 vinyl groups. Examples include styrene and 1,4 divinyl benzene. The vinyl group(s) may be substituted or unsubstituted, e.g. substituted styrenes. Suitable vinyl group substituents include C₁₋₆ alkyl (preferably at the alpha-carbon atom) e.g. methyl. Examples include alpha-methyl styrene. The vinyl substituted aryl may also have at least 1, preferably 1 to 5 substituents on the aryl ring. Thus, phenyl may be substituted by 1 to 5 substituents. Suitable aryl ring substituents e.g. phenyl ring substitutents may be C₁₋₆ alkyl, C₁₋₆ alkenyl, C₁₋₆ alkoxy, halogen, carboxy and nitro.

Examples of acrylates include methyl acrylate, ethyl acrylate, butyl acrylate, 2-ethylhexyl acrylate, isobornyl acrylate, and functional derivatives thereof such as 2-hydroxy ethyl acrylate, 2-chloro ethyl acrylate and the like. Such acrylates generally have from 1 to 30 carbons, preferably from 1 to 8 carbons.

Examples of methacrylates are methyl methacrylate, ethyl methacrylate, butyl methacrylate, 2-ethylhexyl methacrylate, isobornyl methacrylate, and functional derivatives thereof such as 2-hydroxy ethyl methacrylate, 2-chloro ethyl methacrylate, 2-hydroxypropyl methacrylate, (HPMA) 2-morpholinoethylmethacrylate (MEMA), 2-(dimethylamino)ethyl methacrylate (DMA), glyerol monomethacrylate (GMA), methoxy capped oligo(ethyleneglycol)methacrylate (OEGMA), poly(ethyleneglycol) methacrylate (PEGMA), glycidyl methacrylate. Such methacrylates generally have from 1 to 30 carbons, preferably from 1 to 8 carbons.

Examples of (meth)acrylamides include (meth)acrylamide itself, N-methyl (meth)acrylamide, N,N′dimethyl (meth)acrylamide and the like.

Examples of acids and anhydrides include (meth)acrylic acid, maleic acid, maleic anhydride, vinyl sulphonic acid, itaconic acid.

Examples of other monomers include amino olefins, vinyl pyridine, N-amino ethyl acrylamide, N-aminoethyl acrylate, isoprene, butadiene, and C₂₋₈ alpha-olefins such as ethylene, propylene, 1-butene, isobutene, 1-hexene, 1-octene and the like.

Particularly preferred monomers are styrene, methyl acrylate, methyl methacrylate, 2-hydroxypropyl methacrylate, (HPMA) 2-morpholinoethylmethacrylate (MEMA), 2-(dimethylamino)ethyl methacrylate (DMA), glyerol monomethacrylate (GMA), methoxy capped oligo(ethyleneglycol)methacrylate (OEGMA), poly(ethyleneglycol) methacrylate (PEGMA), glycidyl methacrylate.

In one preferred embodiment of the invention, a mixture of two or more monomers may be used.

With regard to the polymerisation reaction using the catalyst composition herein described, the relative proportions of initiator and metal complex component are those effective to achieve the desired polymer product.

The molar ratio of initiator to monomer is chosen depending on the molecular weight of the product polymer to be achieved. For molecular weights of e.g. polystyrene or polymethyl methacrylate in the range 50 k-1 million the initiator is preferably present in a molar ratio of from 2×10⁻³:1 to 10⁻⁴:1 relative to monomer. For the molecular weight range 100 k-600 k, the initiator is preferably present in a molar ratio of from 10⁻³:1 to 1.6×10⁴:1 relative to monomer, and to obtain polymer product of molecular weight in the range 250 k-500 k, the initiator is preferably present in a molar ratio of from 4×10⁻⁴ to 2×10⁻⁴:1 relative to monomer.

The molar ratio of initiator to the metal complex component to effect polymerisation can depend upon the degree of solubility of the metal complex component in the reaction system but is preferably from 10⁻⁴:1 to 10:1, more preferably from 10⁻¹: to 5:1, more preferably still from 0.3:1 to 2:1, and especially from 0.9:1 to 1.1:1. The greater the degree of solubility of the metal complex component the greater the concentration of metal there will be present in the reaction system. Consequently in a homogeneous system the molar proportion of metal component to initiator may be reduced, e.g. 10⁻³:1.

The polymerisation of the present invention is optionally carried out in the presence of solvent. Suitable solvents include protic and non-protic solvents such as water, aromatic hydrocarbon solvents, ethers, cylic ethers, C₅₋₁₀ alkanes, halogenated hydrocarbon solvents (which may or may not act as an initiator under the reaction conditions), acetonitrile, propionitrile, dimethylformamide and C₁₋₆ alcohols. Suitable aromatic hydrocarbon solvents include benzene, toluene, xylene (all isomers), and ethylbenzene. Suitable ethers include diethyl ether, dimethoxyethane, diethoxyethane, diphenyl ether, anisole. Suitable cyclic ethers include dioxane and tetrahydrofuran. Suitable C₅₋₁₀ alkanes include hexane, heptane. Suitable halogenated hydrocarbon solvents include dichloromethane, 1,2 dichloroethane. Suitable C₁₋₆ alcohols include methanol, ethanol, propanol.

The polymerisation process is preferably carried out at a temperature in the range −20° C. to 200° C., preferably 100 to 180° C. for bulk polymerisation. Aqueous suspension polymerisation temperatures are typically from 80 to 100° C. Where polymerisation can be initiated by thermally generated radicals, such as with styrene, it is beneficial to conduct the reaction at as low a temperature as possible to ensure the maximum control over molecular weight and molecular weight distribution by the catalyst complex. Thus it is beneficial to carry out styrene polymerisation below 160° C., more preferably below 130° C., and most preferably at or below 120° C.

The polymerisation process of the present invention is preferably carried out in the presence of an activator, such as a Lewis acid activator. Typical Lewis acids which may be used include aluminium alkyls, e.g. methyl aluminium bis(2,6 di-tert-butylphenoxide), aluminium alkoxides such as aluminium tris(iso-propoxide), aluminium halides such as aluminium trichloride, alkyl zinc reagents such as diethyl zinc and boranes such as BPh₃ and B(C₆F₅)₃.

The use of an activator may increase the rate of polymerisation, for example the rate of polymerisation of (meth)acrylate esters of C₁₋₂₀ alcohols e.g. methyl methacrylate, and in particular methyl methacrylate polymerisation in the presence of an aluminium activator.

The molar ratio of activator to metal complex used is preferably in the range from 1:1 to 10:1, for example, 2:1 to 6:1.

The polymerisation process may be carried out in bulk, solution, emulsion or suspension (slurry), as a single phase or multiple phases. Gas phase polymerisation can be carried out wherein the monomer in gaseous phase contacts a bed of the catalyst supported on a suitable substrate which has been previously contacted with the initiator(s) and ligand. Bulk polymerisations are particularly advantageous. The invention can be practiced as a batch, semicontinuous, or continuous process. Monomers, initiator, catalyst, and optionally solvent, are mixed together in a suitable reaction vessel. The order of component addition is not critical although, it is desirable that monomer is present before others items are introduced. This vessel may be purged with an inert gas, such as nitrogen. The gas purge may be continued throughout reaction. Polymerisation may be carried out with all monomers present at the beginning or with monomers added incrementally or continuously throughout the reaction. The reaction mixture may be agitated by any known method to mix components. The reaction is continued until the desired level of polymerisation has occurred, generally from about 40% to about 100% conversion of monomer to polymer. The reaction mixture may then be treated as required in subsequent steps to achieve the final desired product. For example, the reaction may be stopped by cooling, addition of inhibitor such as 4-methoxyphenol and the like, and discontinuing monomer feed. Alternatively, the reaction mixture may be taken on to further work-up stages such as catalyst removal steps, and/or polymer isolation.

The polymers and copolymers formed by the process of the present invention include straight and branched chain polymers and copolymers, star (co)polymers and the like. The copolymers can be random, alternating, block, graft, multiblock, straight chain, star, star block copolymers and the like. The (co)polymers may also be high impact polystyrene wherein a natural or synthetic rubber or a combination thereof is grafted onto the polymer or copolymer.

The polymers of the invention may also be used in blends with other polymers, or conventionally polymerised versions of the same polymers, to modify their properties for different applications.

The polymers and copolymers may be further processed by moulding, spinning, extruding, and the like. Additives include lubricants, dyes, plasticisers, pigments, stabilisers, antistatic agents, antioxidants, fillers and blowing agents. Utilisations for the polymers and copolymers include moulded or foamed articles, sheets, films, pipes, tubings, fibres and the like.

The present invention is further described by way of example, and with reference to the following figures wherein:

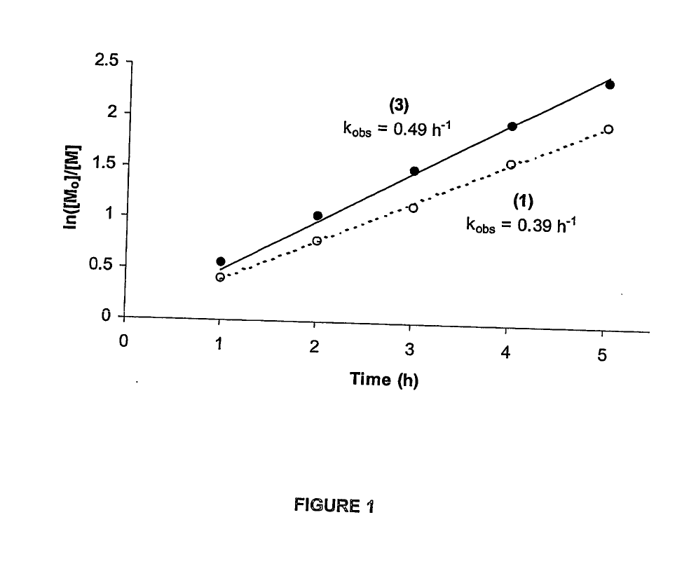

FIG. 1 shows a first order kinetic plot of ln[M]₀/[M] versus time for the polymerization of styrene, St, using complexes 1 and 3 ([catalyst]₀=1.0×10⁻³ M, [1-PEBr]₀=1.0×10⁻³ M, [St]₀=0.1 M; 1-PEBr=1-phenylethylbromide).

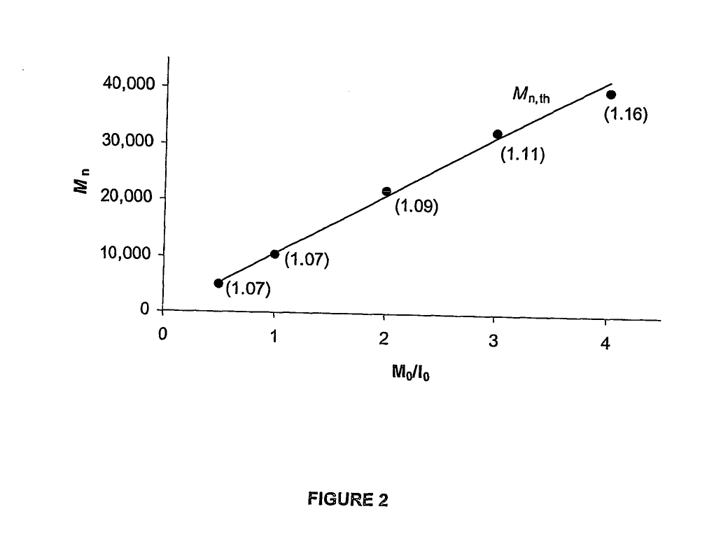

FIG. 2 shows a plot of molecular weight versus M₀/I₀ for the polymerization of styrene, St, using 1, with M_{w}/Mₙ in parenthesis. ([1]₀=1.0×10⁻³ M, [(1-PEBr]₀=1.0×10⁻³ M, [St]₀=0.05 M, 0.1 M, 0.2 M, 0.3M and 0.4 M; 1-PEBr=1-phenylethylbromide).

### EXAMPLES

Synthesis of Tridentate NNOFeCl and NNOFeCl₂ complexes

NNOFeCl

The complexes 1-3 were readily prepared according to Scheme 1. The ligands (I-III) were dissolved in tetrahydrofuran and then added dropwise to an excess of NaH in tetrahydrofuran at 0° C. The suspension was stirred overnight at room temperature and then filtered. The filtrate was then added dropwise to stirred suspension of FeCl₂ in tetrahydrofuran and stirred for a further 16 hours. The solution was pumped to dryness followed by extraction into pentane and removal of solvent to afford 1-3 as microcrystalline, dark, paramagnetic solids in good yields. 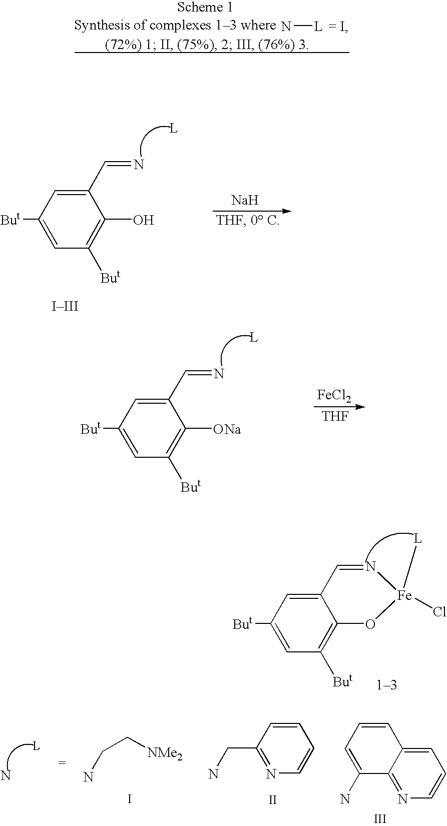
Characterisation

1:IR NaCl) 2952m, 2770m, 1612s, 1459m, 1436w, 1413w, 1361w, 1320w, 1272w, 1255w, 1169w, 1025w, 878w, 839w. Anal. Calc. For FeClC₁₉H₃₁N₂O: C, 57.81; H, 7.92; N, 7.10; Cl, 8.98. Found: C, 57.80; H, 7.70; N, 6.87; Cl, 8.23%. MS (—CI/NH₄) (m/z): [LFeCl]⁻=394. μ_{eff}=3.64 BM.

2 IR (NaCl) 2964w, 2881w, 2362w, 1614s, 1535m, 1483m, 1430m, 1393w, 1322w, 1274w, 1274w, 1172w, 1067w, 1051w, 1021w, 841w, 760w. Anal. Calc. For FeClC₁₉H₃₁N₂O: C, 60.81; H, 6.56; N, 6.75; Cl, 8.55. Found: C, 60.63; H, 6.58; N, 6.75; Cl, 8.13%. MS (—CI/NH₄) (m/z): [LFeCl])=414. μ_{eff}=3.70 BM.

3: IR (NaCl): 2960m, 2902w, 1521m, 1498m, 1459w, 1415w, 1382w, 1160w, 1131w, 1085w, 1065w, 828w, 793w. Anal. Calc. For FeClC₁₉H₃₁N₂O: C, 63.95; H, 6.04; N, 6.21; Cl, 7.86. Found: C, 63.93; H, 6.17; N, 6.42; Cl, 7.58%. MS (—CI/NH₄) (m/z): [LFeCl]⁻=450. μ_{eff}=3.79 BM.

NNOFeCl₂

The complexes 4-6 were readily prepared according to Scheme 2. The ligands (I-III) were dissolved in tetrahydrofuran and then added dropwise to an excess of NaH in tetrahydrofuran at 0° C. The suspension was stirred overnight at room temperature and then filtered. The filtrate was then added dropwise to stirred solution of FeCl₃ in tetrahydrofuran and stirred for a further 16 hours. The solution was pumped to dryness followed by extraction into dichloromethane and removal of solvent to afford 4-6 as microcrystalline, dark, paramagnetic solids in good yields. 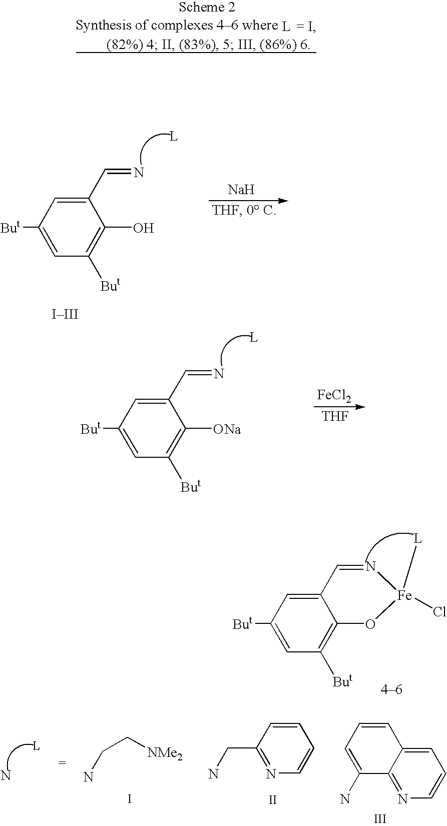
Characterisation

4: IR (NaCl) 2956 (s), 2929 (s) 2856 (s), 1608 (m), 1537 (m), 1462 (w), 1415 (w), 1377 (m), 1254 (m), 1174 (m), 1046 (w), 893 (m), 847 (s), 781 (m), 738 (s) Anal. Calc. For FeCl₂C₁₉H₃₁N₂O: C, 52.92; H, 7.48; N, 6.50; Cl, 16.44. Found: C, 53.03; H, 7.56; N, 6.43; Cl, 16.09%. MS (—CI/NH₄) (m/z): [LFeCl₂]⁻=429. μ_{eff}=5.91 BM.

5: IR (NaCl) 2957 (s), 1614 (s) 1572 (w), 1537 (s), 1463 (w), 1415 (m), 1391 (w), 1361 (m), 1312 (m), 1272 (m), 1254 (s), 1173 (m), 1052 (s), 1021 (w), 842 (m) 782 (w), 666 (s). Anal. Calc. For FeCl₂C₁₉H₃₁N₂O: C, 55.90; H, 6.25; N, 6.21; Cl, 15.71. Found: C, 55.96; H, 6.20; N, 6.29; Cl, 14.86%. MS (—CI/NH₄) (m/z): [LFeCl₂-HCl]=⁻414. μ_{eff}=5.94 BM.

6: IR (NaCl) 2952w, 2902w, 1598m, 1583m, 1531m, 1504, 1461w, 1413w, 1318w, 1250w, 1167w, 1089w, 831w, 786w. Anal. Calc. For FeCl₂C₉H₃₁N₂O: C, 59.26; H, 5.56; N, 5.76; Cl, 14.64. Found: C, 59.16; H, 5.41; N, 5.64; Cl, 14.35%. MS (—CI/NH₄) (m/z): [LFeCl₂]⁻=485. μ_{eff} =6.07 BM.

Polymerisation Procedure

Normal ATRP Using Complexes 1-3

Polymerisations were performed under nitrogen, in a 15 cm³ glass ampoule fitted with a Teflon stopcock. The ampoule was equipped with a magnetic stirrer bar and the following were placed in it in the order, monomer, initiator, solvent and catalyst. The ampoules were transferred to a preheated oil bath. For styrene, polymerisations were performed at 120° C. in bulk and 85° C. for solvent (toluene) mediated polymerisations. For MMA polymerisations were performed at 90° C. in bulk and 60° C. for solvent (benzene) mediated polymerisations. After magnetic stirring for the allotted period of time an aliquot (0.1 ml) was removed and quenched by addition of THF (1 ml). Conversion was determined by integration of monomer vs. polymer backbone resonances in the ¹H NMR spectrum of the crude product (in CDCl₃). The polymer was purified by precipitating from a rapidly stirred acidified (5%) methanol solution. GPC chromatograms were recorded on a Knauer differential refractometer connected to a Gynotek HPLC pump (model 300) and two 10 μm columns (PSS) at a flow rate of 1.00 cm³ min⁻¹ using CHCl₃ as the eluent. The columns were calibrated against PS standards with molecular weights ranging from 1560 to 128 000 or PPMA standards from 960 to 174,000. Analysis was performed using Version 3.0 of the Conventional Calibration module of the Viscotek SEC³ software package.

Reverse ATRP Using Complexes 4-6

Polymerisations were described as for normal ATRP except AIBN (Aldrich) was used as an initiator. For styrene, polymerisations were performed at 90° C. in bulk and 85° C. for solvent (toluene) mediated polymerisations. For MMA polymerisations were performed at 90° C. in bulk and at 80° C. for solvent (benzene) mediated polymerisations.

Polymerisation Results for Normal ATRP, (Styrene Monomer)

Bulk Polymerisations

FIG. 1 shows a first order kinetic plot of ln[M]₀/[M] versus time for complexes 1 and 3. ([catalyst]₀32 1.0×10⁻³ M, [1-PEBr]₀=1.0×10⁻³ M, [St]₀=0.1 M).

For 2 k_{obs}=0.46 h⁻¹

FIG. 2 shows a plot of molecular weight versus M₀/I₀ for 1 with M_{w}/Mₙ in parenthesis. ([1]₀=1.0×10⁻³ M, [1-PEBr]₀=1.0×10⁻³ M, [St]₀=0.05 M, 0.1 M, 0.2 M, 0.3M and 0.4 M).

Solvent Mediated Polymerisations

The results of styrene polymerisation using 1-3 (in toluene) are collected in Table 1.

TABLE 1

| Catalyst | K_{obs}/h⁻¹ | Mn, th | Mn | Mw/Mn |
|---|---|---|---|---|
| 1 | 0.06 | 8,100 | 8,250 | 1.09 |
| 2 | 0.10 | 8,800 | 8,900 | 1.11 |
| 3 | 0.15 | 8,200 | 8,300 | 1.08 |

The results for the polymerisation of MMA (bulk) using 1-3 are collected in Table 2.

TABLE 2

| Catalyst | Kobs/h⁻¹ | Mn, th | Mn | Mw/Mn |
|---|---|---|---|---|
| 1 | 0.31 | 9,400 | 9,100 | 1.22 |
| 2 | 0.40 | 9,200 | 9,000 | 1.10 |
| 3 | — | — | — | — |

The polymerisation results for reverse ATRP using 4-6 (styrene monomer) are collected in Table 3.

TABLE 3

| Catalyst | Kobs/h⁻¹ | Mn, th | Mn | Mw/Mn |
|---|---|---|---|---|
| 4 | 0.36 | 19,900 | 37,200 | 1.38 |
| 5 | 0.51 | 19,500 | 33,800 | 1.32 |
| 6 | 0.25 | 17,700 | 16,500 | 1.15 |

Various modifications and variations of the described methods of the invention will be apparent to those skilled in the art without departing from the scope and spirit of the invention. Although the invention has been described in connection with specific preferred embodiments, various modifications of the described modes for carrying out the invention which are obvious to those skilled in chemistry or related fields are intended to be within the scope of the following claims.

1. A compound of formula I 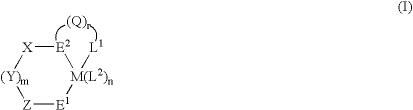
wherein
each of X, Y, Z is independently selected from O, S, NR¹, CR²R³, N and CR⁴, and where optionally X—Y, Y-Z, Z-E¹ and X-E² each independently form part of a saturated or unsaturated ring system which may be substituted or unsubstituted;
m is 0 or 1;
M is a metal selected from Ti[III], Ti[IV], Fe[II], Fe[III], Co[I], Co[II], Co [III], Ni[II], Cr[III], Mn[II]; Mn[III]; Mn[IV], Ru[II], Ru[III], Ru[IV], Pd[II], V[II], V[III], V[IV], V[V], Cu[I], Cu[II], Rh[I], Rht[III], Mo[III], Mo[V], Re[I] and Re[II];
each of E¹ and E² is independently selected from O, S, NR⁵, N, P, PR⁶, where at least one of either E¹ or E² carries a formal negative charge;
L² is a one electron donor ligand;
n is zero or an integer such that the compound has an overall charge of zero or +1;
L¹ is NR⁷R⁸, PR⁷R⁸, OR⁷, SR⁷, O, S or NR¹⁶, imidazolyl, pyridinyl, benzimidazolyl or quinolinyl;
each of R¹⁻⁸ and R¹⁶ is independently H or a hydrocarbyl group;
Q is a linker group; and
r is 0 or 1.

2. A compound according to claim 1 wherein L² is selected from halide, hydride, alkyl and cyanide.

3. A compound according to claim 1 wherein L² is chloride or bromide.

4. A compound according to claim 1 wherein X, Y and Z are each independently selected from CR²R³ and CR⁴.

5. A compound according to claim 4 wherein:
(i) m is 1, each of X-E² and Y-Z is independently a single or a double bond or part of a delocalised π system, and X—Y and Z-E¹ are single bonds; or
(ii) m is 1, each of X—Y and Z-E¹ is independently a single or a double bond or part of a delocalised π system, and Z-E² and Y-Z are single bonds; or
(iii) m is 0, each of X-E² and Z-E¹ is independently a single or a double bond or part of a delocalised π system, and X-Z is a single bond.

6. A compound according to claim 1 wherein m is one, Y-Z is a double bond or part of a delocalised π system, and X-E² is a single or a double bond.

7. A compound according to claim 1 which, comprises a compound of formula II 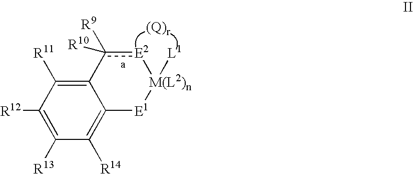
wherein each of R⁹⁻¹⁴ is independently H, a hydrocarbyl group, a halide, ether, thioether, ester, nitro, dialkylamino, or cyano group, and “a” is a double bond or part of a delocalised π system (where one of R⁹ or R¹⁰ is absent), or “a” is a single bond.

8. A compound according to claim 1 wherein X-E² is a double bond or part of a delocalised π system, and E² is N.

9. A compound according to claim 1 wherein X-E² is single bond and E² is NR⁵.

10. A compound according to claim 1 wherein E¹ is O.

11. A compound according to claim 1 which comprises a compound of formula III or IV 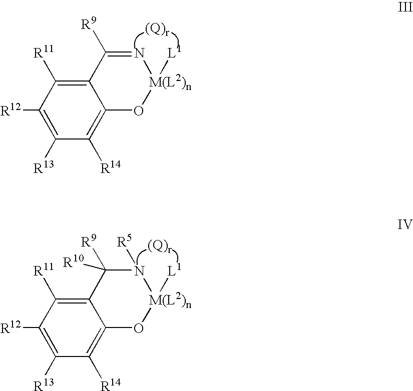
wherein each of R⁹⁻⁴ is independently H, a hydrocarbyl group, a halide, ether, thioether, ester, nitro, amino or cyano group.

12. A compound according to claim 1 wherein M is Fe.

13. A compound according to claim 1 wherein L² is chloride or two.

14. A compound according to claim 1 wherein m is 0, X-E² and Z-E¹ are both double bonds or each form part of a delocalised π system, and X-Z is a single bond.

15. A compound according to claim 1 wherein said compound is of formula V, VI or VII 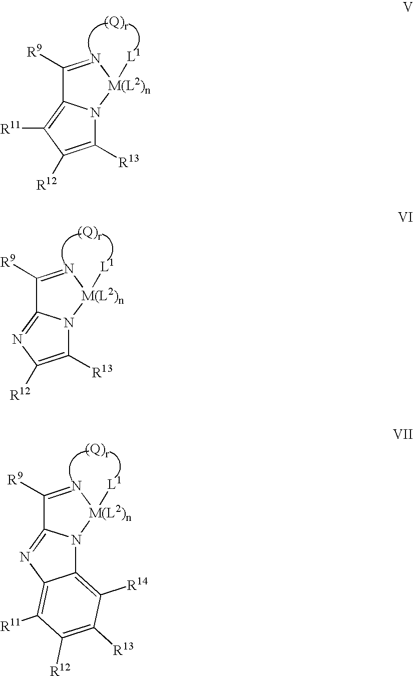
wherein each of R⁹⁻¹⁴ is independently H, a hydrocarbyl group, a halide, ether, thioether, ester, nitro, dialkylamino, or a cyano group.

16. A compound according to claim 1 wherein L¹ is selected from the following: O, —S, —NR¹⁶,

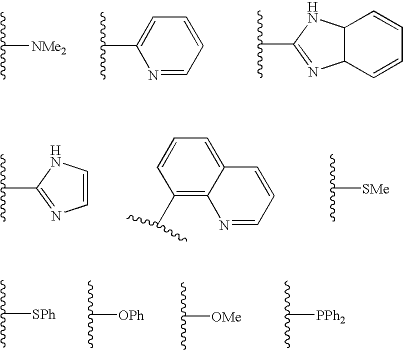

17. A compound according to claim 1, wherein the linker group Q is —(CHR¹⁵)_{P}— or a phenylene group, where p is 1, 2, 3 . . . 10, and each R¹⁵ is independently H or a hydrocarbyl group.

18. A compound according to claim 17 wherein the linker group Q is o-phenylene or —(CH₂)_{P}— where p is 1 or 2.

19. A compound according to claim 1 wherein r is 1.

20. A compound according to claim 1 wherein each of R¹⁻¹⁵ is independently a C₁₋₅₀ alkyl optionally comprising one or more heteroatoms, aryl or a heteroaryl.

21. A compound according to claim 1, wherein each, of R¹⁻¹⁵ is independently a C₁₋₂₀ alkyl.

22. A compound according to claim 1 wherein said compound of formula I is selected from the following:

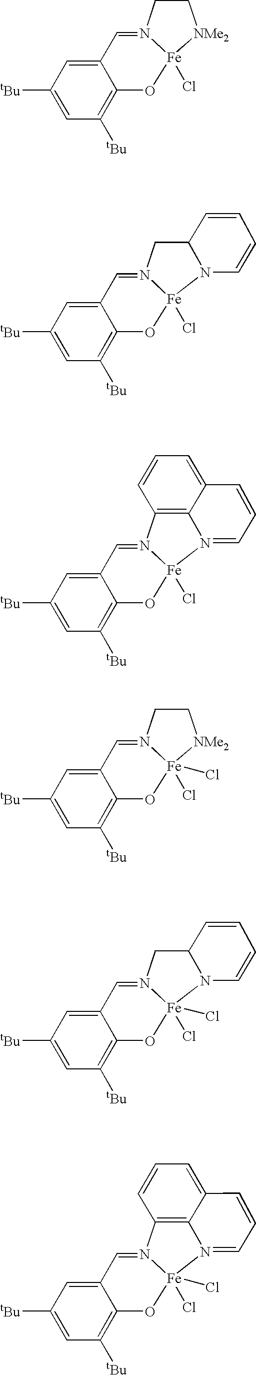

23. A catalyst composition comprising a compound according to claim 1 and an initiator.

24. A catalyst composition according to claim 23 wherein the initiator has a radically transferable atom or group.

25. A catalyst composition according to claim 23 wherein the initiator is selected from an alkyl halide optionally containing an electron withdrawing group in the alpha position, a substituted or unsubstituted arenosulphonyl halide, an alkyl dihalide, a sulphonyl halide and a polymer bearing one or more radically transferrable group.

26. A catalyst composition according to claim 23 wherein the initiator is selected from CCl₄, CHCl₃, CCl₃Br, 2-bromoethylisobutyrate, 2-bromoisobutyrophenone, para-toluenesulphonyl chloride, phenoxybenzene-4,4′-disulphonyl chloride, 1,3-benzene disulphonyl chloride.

27. A catalyst composition according to claim 23 wherein the initiator is AIBN.

28. A catalyst composition according to claim 23 wherein the compound of formula I is supported on an inorganic or organic solid support.

29. Use of a compound according to claim 1, or a catalyst composition, for polymerising a radically polymerisable monomer.

30. A process for polymerising a radically polymerisable monomer, said process comprising contacting a catalyst composition according to claim 23 with a radically polymerisable monomer, optionally in the presence of a solvent.

31. A process according to claim 30 wherein the radically polymerisable monomer is selected from one or more of the following: C₂₋₈ alpha olefins, optionally substituted conjugated dienes, acrylic acid, acrylic anhydride, (meth)acrylamides, vinyl halides, (meth)aciylonitrile, (meth)acrylate esters of C₁₋₂₀ alcohols, vinyl esters of C₁₋₂₀ alcohols, vinyl amides having up to 8 carbons, vinyl ketones having up to 8 carbons, vinyl substituted aryls.

32. A process according to claim 30 wherein the radically polymerisable monomer is an acrylate selected from the following: methyl acrylate, ethyl acrylate, butyl methacrylate, 2-ethyhexyl acrylate, isobornyl acrylate, and functional derivatives thereof such as 2-hydroxy ethyl acrylate, 2-chloro ethyl acrylate.

33. A process according to claim 30 wherein the radically polymerisable monomer is a methacrylate selected from the following: methyl methacrylate, ethyl methacrylate, butyl methacrylate, 2-ethylhexyl methacrylate, isobornyl methacrylate, 2-hydroxy ethyl methacrylate, 2-chloro ethyl methacrylate, 2-hydroxypropyl methacrylate, (HPMA) 2-morpholinoethylmetliacrylate (MEMA), 2-(dimethylamino)ethyl methacrylate (DMA), glyerol monomethacrylate (GMA), methoxy capped oligo(ethyleneglycol)methacrylate (OEGMA), poly(ethyleneglycol)methacrylate (PEGMA), glycidyl methacrylate.

34. A process according to claim 30 wherein the radically polymerisable monomer is a (meth)acrylamide selected from the following: (meth)acrylamide, N-methyl (meth)acrylamide and, N,N′dimethyl (meth)acrylamide.

35. A process according to claim 30 wherein the radically polymerisable monomer is selected from the following: styrene, methyl acrylate, methyl methacrylate, 2-hydroxypropyl methacrylate, (HPMA) 2-morpholinoethylmethacrylate (MEMA), 2-(dimethylamino)ethyl methacrylate (DMA), glyerol monomethacrylate (GMA), methoxy capped oligo(ethyleneglycol)methacrylate (OEGMA), poly(ethyleneglycol)methacrylate (PEGMA) and glycidyl methacrylate.

36. A process according to claim 30 wherein the ratio of initiator to radically polymerisable monomer is from 2×10⁻³:1 to 1×10⁴:1.

37. A process according to claim 30 wherein the ratio of initiator to radically polymerisable monomer is from 1×10⁻³:1 to 1.6×10⁻⁴:1.

38. A process according to claim 30 wherein the ratio of initiator to radically polymerisable monomer is from 4×10⁻⁴:1 to 2×10⁻⁴:1.

39. A process according to claim 30 wherein the ratio of initiator to the compound of formula I is from 1×10⁻⁴:1 to 10:1.

40. A process according to claim 30 wherein the ratio of initiator to the compound of formula I is from 1×10⁻¹:1 to 5:1.

41. A process according to claim 30 wherein the polymerisation takes place at a temperature of from about −20° C. to 200° C.

42. A process according to claim 30 wherein the polymerisation takes place in the presence of a Lewis acid activator.

43. A process according to claim 42 wherein the Lewis acid activator is an aluminium alkyl, an aluminium alkoxide, an aluminuim halide an alkyl zinc reagent, or a borane.

44. A process according to claim 43 wherein the Lewis acid activator is selected from methyl aluminium, bis(2,6 di-tert-butylphenoxide), aluminium tris(iso-propoxide), aluminium trichloride, diethyl zinc, BPh₁₃ and B(C₆F₅)₃.

45. A process according to claim 42 wherein the ratio of activator to the compound of formula I is from 1:1 to 10:1.

46. A process according to claim 29 wherein the polymerisation is carried out in bulk, solution, emulsion, suspension or in the gas phase.

47. A polymerisation mixture comprising a catalyst composition according to claim 23 and a radically polymerisable monomer, which optionally further comprises a solvent and/or a Lewis acid activator.
